(19) United States
(12) Patent Application Publication
(10) Pub. No.: US 2008/0122649 A1
(43) Pub. Date: May 29, 2008

(54) AUTOMATIC ALARM SYSTEM AND METHOD FOR PORTABLE ELECTRONIC APPARATUS

(75) Inventors: FANG-HUA LIU, Shenzhen (CN); SHIH-FANG WONG, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 11/773,410

(22) Filed: Jul. 4, 2007

(30) Foreign Application Priority Data
Jul. 5, 2006 (CN) 200610061514.3

(51) Int. Cl. G08B 5/22

(52) U.S. Cl. 340/825.36; 455/410

(57) ABSTRACT

An automatically alarm method for a portable electronic apparatus is provided. The method includes the step of: setting the portable electric apparatus in an anti-theft mode according to a setting signal; generating an request signal; transmitting the request signal to a wireless signal sending apparatus; generating an alarm instruction when not receiving an response signal in a predetermined time; and outputting a prerecorded voice file according to the alarm instruction.

### BACKGROUND OF THE INVENTION

1. Field of the Invention

The present invention relates automatic alarm system and method for portable electric apparatus.

2. Description of Related Art

As portable communication devices become smaller and lighter, it also becomes more susceptible to lost and theft.

There is a system for preventing the lost or theft of the portable personal possession such as handset or wallet. The system includes a first plastic card and a second plastic card. The first plastic card and the second plastic card can communicate with each other within a predetermined range. In brief, the first plastic card intermittently transmits an identification code to a second card. The second plastic card compares that transmitted code with a code stored in an internal register, and upon matching those codes, transmits a return code to the first card. The first card compares the return code with a code in an internal register, and upon matching those codes, resets a timer. If the timer is not reset during a predetermined number of transmissions by the first plastic card, an alarm is activated. When the system is used, one card may be attached to the portable personal possession, while the other is placed elsewhere on the person.

However, two IC cards must be used in prior art system. One of the cards must be physically attached to the device being protected and the other card must be “attached” to the operator. This is burdensome.

Therefore, what is still needed is a portable electric apparatus with an anti-theft mode which has less burdensome and more efficient than prior art systems.

### SUMMARY OF THE INVENTION

A communication system with an alarm function is provided. The communication system comprises a wireless signal sending apparatus and a portable electronic apparatus. The portable electronic apparatus includes a data storage, a speaker, and a CPU. The data storage is for storing a prerecorded voice file. The CPU includes an anti-theft mode setting module, a communication module, and an alarm module. The anti-theft mode setting module is for setting the portable electronic apparatus in an anti-theft mode according to a setting signal. The communication module is for generating an request signal in the anti-theft mode, transmitting the request signal to the wireless signal sending apparatus, and generating an alarm instruction when not receiving an response signal from the wireless signal sending apparatus in a first predetermined time. The alarm module is for obtaining the prerecorded voice file from the data storage and outputting the prerecorded voice file through the speaker, according to the alarm instruction.

An automatically alarm method for a portable electronic apparatus is provided. The method includes the step of: setting the portable electric apparatus in an anti-theft mode according to a setting signal; generating an request signal; transmitting the request signal to a wireless signal sending apparatus; generating an alarm instruction when not receiving a response signal in a predetermined time; and outputting a prerecorded voice file according to the alarm instruction.

Other advantages and novel features will be drawn from the following detailed description of the preferred embodiment with reference to the attached drawings, in which:

### BRIEF DESCRIPTION OF THE DRAWINGS

FIG. 1 is an exemplary block diagram of a communication system with an alarm function in accordance with a preferred embodiment of the present invention;

FIG. 2 is a function module diagram of the CPU 111 of FIG. 1; and

FIG. 3 is a flow chart of an automatic alarm method, which is performed by the system of FIG. 1.

### DETAILED DESCRIPTION OF THE INVENTION

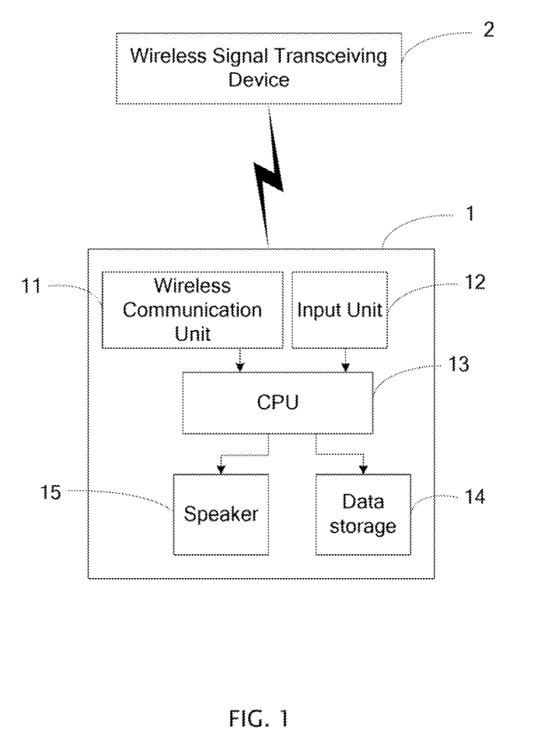

FIG. 1 is an exemplary hardware infrastructure diagram of a communication system with an alarm function (hereafter “the system”) in accordance with the preferred embodiment of the present invention. The system includes a portable electronic apparatus 1 and a wireless signal transceiving device 2. The portable electronic apparatus 1 is connected with the wireless signal transceiving device 2 by a wireless network, such as a Bluetooth network, a WiFi network, or an 802.11 wireless network. The wireless signal transceiving device 2 can be a Bluetooth handset.

The apparatus 1 includes a wireless communication unit 11, an input unit 12, a CPU (central processing unit) 13, a data storage 14, and a speaker 15. The data storage 14 stores a prerecorded voice file.

The apparatus 1 can be set in an anti-theft mode according to a setting signal. The setting signal can be generated from the wireless signal transceiving device 2 through the wireless communication unit 11 or be generated from the input unit 12 in response to an operation of a user. In the anti-theft mode, the CPU 111 constantly sends a request signal to the wireless signal transceiving device 2 at a predetermined interval, and the wireless signal transceiving device 2 sends a response signal to the apparatus 1 once receiving the request signal from the apparatus 1.

Generally, a coverage area of the wireless network is limited. Take the Bluetooth network for example, the coverage area of the Bluetooth network is within 300 square meters. When a distance between the wireless signal transceiving device 2 and the apparatus 1 goes beyond the coverage area of the Bluetooth network, the communication between the wireless signal transceiving device 2 and the apparatus 1 would cease. Thus, the Bluetooth network would be unable to perform any transmission between the apparatus 1 and the wireless signal transceiving device 2.

If the apparatus 1 does not receive the response signal within a predetermined time, the CPU 11 determines that the apparatus 1 is in an alarm state, that is the CPU 11 would compute that the apparatus 1 might be misplaced, lost, or stolen, and implements an alarm function. That is, the CPU 11 locks the input unit 12 to disable operations to the input unit 12, and outputs the predetermined voice file read from the data storage 14 through the speaker 15. Contents of the prerecorded voice file can be “I am stolen/lost” or other prerecorded distress alarm or signal. Therefore, when the distance between the wireless signal transceiving device 2 and the apparatus 1 goes beyond an effective coverage area of the wireless network, the apparatus 1 automatically generates an alarm to remind the user and disables the input unit 12 thereof.

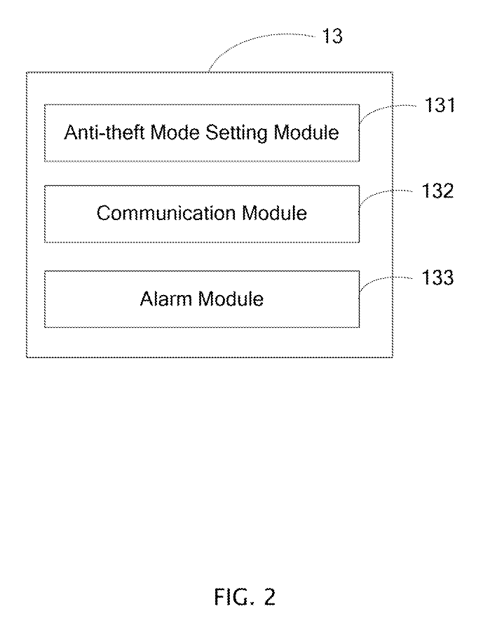

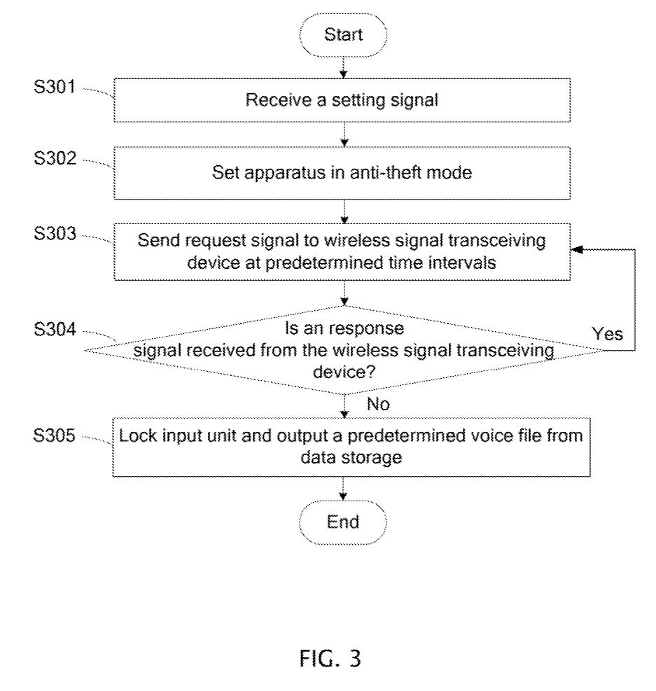

FIG. 2 is a function module diagram of the CPU 11 of FIG. 1. The CPU 11 includes an anti-theft mode setting module 131, a communication module 132, and an alarm module 133. The detailed description of the function of each function module can refer to the FIG. 3.

FIG. 3 is a flow chart of an automatic alarm method, which is performed by the system of FIG. 1.

In step S301, the anti-theft mode setting module 131 receives the setting signal transmitted from the wireless signal transceiving device 2 or the input unit 12.

In step S302, the anti-theft mode setting module 131 sets the apparatus 1 in the anti-theft mode according to the setting signal.

In step S303, the communication module 132 sends the request signal to the wireless signal transceiving device 2 at a first predetermined time interval.

In step S304, the communication module 132 determines whether the response signal is received from the wireless signal transceiving device 2. If the communication module 132 receives the response signal, the procedure goes to step S302 described above.

If the communication module 132 does not receive the response signal, the communication module waits for a second predetermined time, in step S305, the communication module 132 generates an alarm instruction, and the alarm module 133 implements the alarm function according to the alarm instruction, that is, the alarm module 133 locks the input unit 12 and obtains the predetermined voice file from the data storage 14, then outputs the predetermined voice file through the speaker 15. In this preferred embodiment, in order to avoid temporary interruption of the communication between the wireless signal transceiving device 2 and the apparatus 1, the second predetermined time is preferably longer than the first predetermined time.

Although the present invention has been specifically described on the basis of a preferred embodiment including a preferred method, the invention is not to be construed as being limited thereto. Various changes or modifications may be made to the embodiment including the method without departing from the scope and spirit of the invention.

What is claimed is:

1. A communication system with an alarm function, comprising:
a wireless signal transceiving apparatus; and
a portable electronic apparatus, comprising:
a data storage for storing a prerecorded voice file;
a speaker;
a CPU (central processing unit), comprising:
an anti-theft mode setting module for setting the portable electronic apparatus in an anti-theft mode according to a setting signal;
a communication module for generating an request signal in the anti-theft mode, transmitting the request signal to the wireless signal sending apparatus, and generating an alarm instruction when not receiving a response signal from the wireless signal sending apparatus in a first predetermined time; and
an alarm module for obtaining the prerecorded voice file from the data storage and outputting the prerecorded voice file through the speaker, according to the alarm instruction.

2. The apparatus as described in claim 1, further comprising an input unit, wherein the setting signal is generated from the input unit in response to a setting operation.

3. The apparatus as described in claim 1, wherein the setting signal is generated from the wireless signal sending apparatus.

4. The apparatus as described in claim 1, wherein the communication module generates the request signal every a second predetermined time.

5. The apparatus as described in claim 4, wherein the first predetermined time is longer than the second predetermined time.

6. The apparatus as described in claim 1, wherein the alarm module further locks the input unit according to the alarm instruction.

7. An automatically alarm method for a portable electronic apparatus, comprising:
setting the portable electric apparatus in an anti-theft mode according to a setting signal;
generating an request signal;
transmitting the request signal to a wireless signal sending apparatus;
generating an alarm instruction when not receiving an response signal in a predetermined time; and
outputting a prerecorded voice file according to the alarm instruction.

8. The method as described in claim 7, further comprising locking an input unit of the portable electronic apparatus according to the alarm instruction.
